(19) United States
(12) Patent Application Publication
(10) Pub. No.: US 2026/0319912 A1
(43) Pub. Date: Oct. 15, 2026

(54) Method and Apparatus for Checking a Piece of Software, Computer Program, Apparatus, and Vehicle

(71) Applicant: Bayerische Motoren Werke Aktiengesellschaft, Muenchen (DE)

(72) Inventors: Daniel Kuelzer, Muenchen (DE); Michael Furchner, Mering (DE)

(21) Appl. No.: 19/117,037

(22) PCT Filed: Jun. 21, 2023
(86) PCT No.: PCT/EP2023/066865

§ 371 Date: Mar. 29, 2025

(30) Foreign Application Priority Data
Oct. 19, 2022 (DE) 10 2022 127 616.3

(51) Int. Cl. G06F 11/36; G07C 5/00

(52) U.S. Cl. CPC G06F 11/36; G07C 5/008

(57) ABSTRACT

A method checks a piece of software for controlling a vehicle function of a vehicle, wherein the software allows access to the vehicle. The method includes transmitting, to a control unit, a control signal indicative of a movement of a user terminal on a trajectory along the vehicle. The method also includes receiving a status signal indicative of a vehicle status. The method further includes checking the software based on the status signal

The present application is the U.S. national phase of PCT Application PCT/EP2023/066865 filed on Jun. 21, 2023, which claims priority of German patent application No. 10 2022 127 616.3 filed on Oct. 19, 2022, the entire contents of which are incorporated herein by reference.

### TECHNICAL FIELD

The present disclosure relates to methods and apparatus for checking a piece of software, and in particular but not exclusively to a concept for checking a piece of software for controlling one or more vehicle functions.

### BACKGROUND

A digital key, as described in Car Connectivity Consortium Digital Key Release 3, can be used to gain access to a vehicle. Parameters for obtaining access can depend on a version of a piece of software which is used to detect the digital key or a position of the digital key. In particular, it may be necessary from time to time to change parameters for access. Therefore, it may be necessary to check the software.

There is therefore a need to provide a method for checking a piece of software for controlling a vehicle function.

### SUMMARY

The above-stated need, as well as others, are addressed by one or more embodiments disclosed herein.

Exemplary embodiments are based on the core idea that a method for checking a piece of software for controlling a vehicle function can be carried out based on a control signal and the reception of a status signal. This enables automated checking of the software. In particular, no human interaction can be required.

Exemplary embodiments relate to a method for checking a piece of software for controlling a vehicle function, wherein the software allows access to the vehicle. The method comprises transmitting, to a control unit, a control signal indicative of a movement of the user terminal on a trajectory along the vehicle. Further, the method comprises receiving, from a control unit, a status signal indicative of a vehicle status and checking the software based on the status signal. Transmitting the control signal allows a movement of the user terminal relative to the vehicle to be triggered. This means it is possible to check whether the user terminal causes, for example, the vehicle to be locked/unlocked, a ranging intent for determining the position of the user terminal to start, or a welcome light to be activated. This means that an automated checking of a piece of software can be performed to allow access to the vehicle. In particular, this allows a software update to be checked.

In one exemplary embodiment, the status signal may also be indicative of a position of the user terminal. In addition, the checking can be based on the position of the user terminal. This can improve the checking of the software functionality for specific vehicle functions. For example, unlocking the vehicle may depend on an exact position of the user terminal. Receiving the position of the user terminal allows the checking of the software to be improved.

In one exemplary embodiment, the method can further comprise transmitting, to the control unit, an orientation signal indicative of an orientation of the user terminal. The orientation signal can trigger a change in the orientation of the user terminal. This allows the software to be checked according to the orientation of the user terminal, which can improve the accuracy of the check.

In one exemplary embodiment, the method may further comprise receiving, from the control unit, a position signal indicative of a position of the user terminal. Receiving the position of the user terminal allows the checking of the software to be improved. The position signal can be used, for example, to verify the status signal (the position of the user terminal) or to replace it.

In one exemplary embodiment, the method may further comprise transmitting, to the control unit, a shielding signal indicative of a shielding to be caused between the user terminal and the vehicle. The shielding signal can be used to readjust the shielding of the user terminal. This allows the software to be checked depending on an attenuated signal from the user terminal, which can improve the accuracy of the check.

Exemplary embodiments relate to a method for checking a piece of software for controlling a vehicle function, wherein the software allows access to a vehicle. The method comprises receiving, from a control unit, control signal indicative of a movement of the user terminal on a trajectory along the vehicle. Furthermore, the method comprises triggering a movement of the user terminal based on the control signal. By receiving the control signal, a trajectory for the user terminal can be determined. Because a movement of the user terminal along the trajectory is triggered based on the control signal, a check of the software for controlling a vehicle function can be carried out automatically.

In one exemplary embodiment, the method may further comprise receiving, from the communication device, an orientation signal indicative of an orientation of the user terminal and triggering a change in the orientation of the user terminal. This means that the orientation of the user terminal can be changed for the purpose of checking the software, which can improve the checking process.

In one exemplary embodiment, the method can further comprise determining a position of a marker of the vehicle and determining a position of the user terminal relative to the vehicle based on the determined position of the marker. Further, the method may comprise transmitting, to the communication devices, a position signal indicative of the position of the user terminal. Determining the position of the marker allows the position of the user terminal to be determined. This allows a comparison of the trajectory with the current position of the user terminal.

Exemplary embodiments also provide a computer program for implementing a method described herein, when the computer program is executed on a computer, a processor or a programmable hardware component.

A further exemplary embodiment is an apparatus for checking a piece of software for controlling a vehicle function. The apparatus comprises an interface for communication with other communication devices (e.g., a communication device, a control unit and/or a control device) and a data processing circuit which is designed for carrying out at least one f the methods described herein. In addition, exemplary embodiments provide a vehicle having an apparatus as described herein.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of a method for checking a piece of software for controlling a vehicle function;

FIG. 2 shows a schematic representation of another method for checking a piece of software for controlling a vehicle function; and

FIG. 3 shows a block diagram of an exemplary embodiment of an apparatus for checking a piece of software for controlling a vehicle function of a vehicle.

### DETAILED DESCRIPTION

Various exemplary embodiments will now be described in more detail with reference to the accompanying drawings, in which several exemplary embodiments are shown. In the figures, the thickness dimensions of lines, layers and/or regions are shown exaggerated for the sake of clarity.

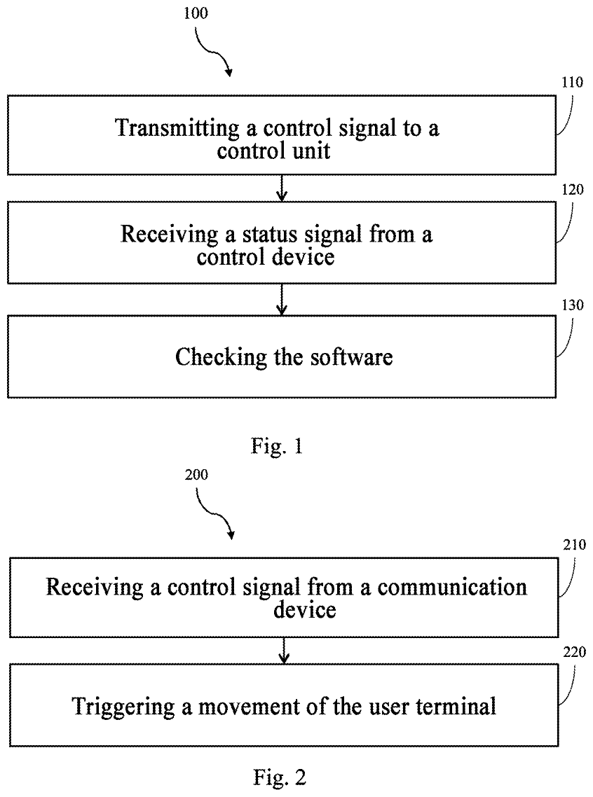

FIG. 1 shows a schematic representation of a method 100 for checking a piece of software for controlling a vehicle function. The method 100 can be executed by a transmitting 110, to a control unit, a control signal indicative of a movement of the user terminal on a trajectory along the vehicle. Further, the method comprises receiving 120, from a control device, a status signal indicative of a vehicle status and checking 130 the software based on the status signal.

A vehicle function can be any function that can be used in the context of using a digital key. For example, a vehicle function can be a welcome light, an unlocking (on an approach of the user terminal), a locking (on removal of the user terminal), transmitting a ranging intent (in particular depending on a position of the user terminal relative to the vehicle), a type of the transmitted ranging intent (e.g., Low_approach_confidence, Medium_approach_confidence, High_approach_confidence).

The control unit can be part of a robot. The robot can be designed to hold the user terminal and perform a movement along a trajectory. By transmitting 110 the control signal, therefore, a movement of the user terminal along the trajectory can be triggered. Thus, the communication device can launch a scenario for checking the software, for example, an approach by the user terminal to the vehicle.

The status signal is received by a control device. For example, the control device may be a control unit of a vehicle. The status signal may include, for example, information about whether the vehicle is unlocked, locked, or a ranging intent has been sent. This means that the communication device can be informed about a successful actuation of a vehicle function.

Based on the status signal, the communication device can then carry out a check of the software. For example, the control signal can comprise a trajectory that should cause the vehicle to be unlocked. It is then possible to check whether the vehicle has been unlocked by means of the status signal. If the vehicle has been unlocked, it can be assumed that the software is functioning correctly. This allows the software to be checked automatically with the communication device.

For example, the communication device may be part of a computer. The computer can give commands to the control unit, for example a robot, for traveling along predefined trajectories, for example by transmitting the control signal. There may be a minimum condition (for example, when the vehicle should be unlocked or locked based on the robot position and thus the position of the user terminal), and the computer can check whether the respective minimum condition has been met or not, for example, based on the received status signal.

In one exemplary embodiment, the status signal may also be indicative of a position of the user terminal. The check can also be based on the position of the user terminal. The information about the position of the user terminal can be used to improve the software check.

Some functions may be based on an exact location of the user terminal. In comparison with the check of whether the minimum condition for unlocking the vehicle has been met, it can also be checked whether unlocking has taken place only in a specific position of the user terminal. For example, a vehicle can only be unlocked if the user terminal is located within a predefined distance of a driver's door. By receiving the position of the user terminal by means of the status signal, it can be checked whether this condition is met.

Alternatively or optionally, in one exemplary embodiment the method 100 may further comprise receiving, from the control unit, a position signal indicative of a position of the user terminal. The position signal can be used to increase the accuracy of the position of the user terminal, for example by comparison with the status signal (the position of the user terminal).

In one exemplary embodiment, the method can further comprise transmitting, to the control unit, an orientation signal indicative of an orientation of the user terminal. The software can be checked for different orientations of the user terminal. For example, a first movement along the trajectory can be triggered by the communication device. Then, a change in the orientation of the user terminal can be triggered by the communication device and a second movement along the trajectory can take place. This allows the user terminal to be checked for the influence of different orientations. This can improve the checking of the software.

In one exemplary embodiment, the method may further comprise transmitting, to the control unit, a shielding signal indicative of a shielding to be caused between the user terminal and the vehicle. The shielding signal can be used to trigger a shielding of the user terminal relative to the vehicle. For example, the robot may be configured to arrange a shielding body, such as a cooling pad or organic material, between the user terminal and the vehicle or to arrange the user terminal behind a shielding body. Thus, the influence of shielding, such as is caused, for example, for a user terminal carried in a trouser pocket, can be determined. This can improve the checking of the software.

The trajectory may be based in particular on a trajectory of a user when moving towards or away from a vehicle. Alternatively or optionally, the trajectory may be based on a user's movement during a charging process, for example, for opening a charging port cover. For example, a user can move with the user terminal from the driver's door toward a charging port to establish a connection between the vehicle and a power source, for example, a charging station. The trajectory of the user or of the user terminal can then be used, for example, to determine an unlocking of a cover of a charging port. This can improve the user experience during the charging process. The status signal may include information about an opening state of the cover of the charging port. This allows the software to be checked with: regard to a charging process.

The communication device may generally be a device capable of wireless communication, for example, a computer with a WLAN interface.

In general the user terminal may be a device capable of communicating wirelessly. In particular, the user terminal can be a mobile user terminal, e. g. a user terminal which is suitable for being carried by a user. For example, the user terminal device can be a user terminal (UT) or user equipment (UE) in the sense of the respective communication standards used for mobile communication. The user terminal may be, for example, a mobile phone, such as a smartphone, or another type of mobile communication device, such as a smartwatch, a laptop, a tablet computer, a pair of autonomous augmented reality glasses, etc. In particular, the user terminal can be configured as a digital key.

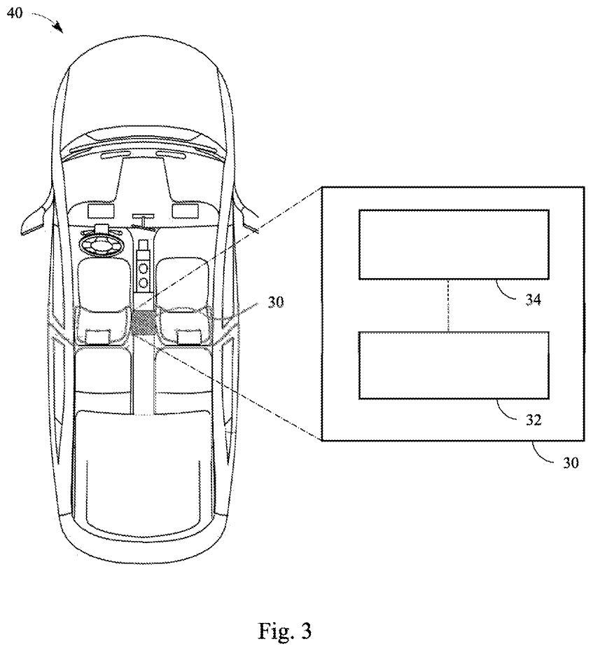

Further details and aspects are mentioned in conjunction with the exemplary embodiments described below. The exemplary embodiment shown in FIG. 1 can comprise one or more optional additional features corresponding to one or more aspects mentioned in connection with the proposed design or with one or more exemplary embodiments described below (e.g. FIGS. 2-3).

FIG. 2 shows a schematic representation of a further method 200 for checking a piece of software for controlling a vehicle function. The method 200 can be carried out by a control unit, which is part of a robot, for example. The method 200 comprises receiving 210, from a communication device, a control signal indicative of a movement of the user terminal on a trajectory along the vehicle. Furthermore, the method 200 comprises triggering 220 a movement of the user terminal based on the control signal. The control signal can be received from a communication device as described above.

Based on the control signal, the control unit can generate control commands. The control commands can be sent to an actuator of the robot. The actuator may be suitable for moving the robot along the trajectory. The user terminal, which can be secured to the robot, can be moved along the trajectory. This can enable automatic checking of the software.

In one exemplary embodiment, the method 200 may further comprise receiving, from the communication device, an orientation signal indicative of an orientation of the user terminal and triggering a change in the orientation of the user terminal. The control unit can trigger a change in the orientation of the user terminal, for example by generating an orientation signal that is sent to an actuator. This allows the software to be checked for different orientations of the user terminal.

In one exemplary embodiment, the method 200 can further comprise receiving, from the communication device, a shielding signal indicative of a shielding to be caused between the user terminal and the vehicle. This allows the software to be checked for different types of shielding of the user terminal. For shielding, for example, a water pad can be arranged between the user terminal and the vehicle.

In one exemplary embodiment, the method 200 can further comprise determining a position of a marker of the vehicle and determining a position of the user terminal relative to the vehicle based on the determined position of the marker. Further, the method 200 can comprise transmitting, to the communication devices, a position signal indicative of the position of the user terminal. By determining the position using the marker, the control unit can synchronize with a local coordinate system of the vehicle. For example, the marker may be a QR tag arranged on a tire, for example. In particular, the control unit can transmit a position of the user terminal to the communication devices by means of the position signal.

As described above, the control unit can be part of a robot. The robot can be partially made of plastic. The use of plastic can reduce the shielding of the user terminal. Furthermore, the robot may be designed to change a height of the user terminal. The control unit can therefore generate a control command to change the height of the user terminal. Furthermore, the robot can comprise a rotatable holder for the user terminal. The control unit can therefore generate a control command to change the orientation of the user terminal.

In general, the control unit can be a device that is capable of wireless communication, for example, a processor with a WLAN interface, for example for communication with the communication device from FIG. 1.

Further details and aspects are mentioned in conjunction with the exemplary embodiments described below and/or above. The exemplary embodiment shown in FIG. 2 can comprise one or more optional additional features corresponding to one or more aspects mentioned in connection with the proposed design or with one or more exemplary embodiments described above (e.g. FIG. 1) or below (e.g. FIG. 3).

FIG. 3 shows a block diagram of an exemplary embodiment of an apparatus 30 for checking a piece of software for controlling a vehicle function of a vehicle 40. The apparatus 30 comprises an interface 32 for communication with a communication device (as described in FIG. 1, for example), a control unit (as described in FIG. 2, for example) and/or a control device. The apparatus 30 further comprises a data processing circuit 34, which is designed for carrying out at least one of the methods described herein, for example, the method which is described with reference to FIG. 1 for the communication device or with reference to FIG. 2 for the control device. Further exemplary embodiments are a vehicle 40 having an apparatus 30. The apparatus 30 may comprise or be the communication device or the control unit.

The interface 32 shown in FIG. 3 can correspond, for example, to one or more inputs and/or one or more outputs for transmitting information, for example in digital bit values, based on a code, within a module, between modules, or between modules of different entities. The interface 32 may be designed, for example, to communicate with other network components via a (radio) network or a local connection network.

In exemplary embodiments, the data processing circuit 34 can be any kind of controller or processor or a programmable hardware component. For example, the data processing circuit 34 can also be implemented as software which is programmed for a corresponding hardware component. In this respect, the data processing circuit 34 can be implemented as programmable hardware with appropriately adapted software. Any type of processors, such as digital signal processors (DSPs), can be used for this. Exemplary embodiments are not restricted to a specific type of processor. Any number of processors or even a plurality of processors is conceivable for the implementation of the data processing circuit 34.

As shown in FIG. 3, the interface 32 can be coupled to the respective data processing circuit 34 of the apparatus 30. In examples, the apparatus 30 can be implemented by one or more processing units, one or more processing devices, any means for processing, such as a processor, a computer or a programmable hardware component, which can be operated with appropriately adapted software. Likewise, the described functions of the data processing circuit 34 can also be implemented in software, which is then executed on one or more programmable hardware components. Such hardware components can be a multi-purpose processor, a digital signal processor (DSP), a microcontroller, etc. The data processing circuit 34 can be capable of controlling the interface 32 so that any data transmission taking place via the interface 32 and/or any interaction in which the interface 32 can be involved can be controlled by the data processing circuit 34.

In one embodiment, the apparatus 30 may comprise a memory and at least one data processing circuit 34, which is functionally coupled to the memory and is configured to carry out one of the methods described above.

In examples, the interface 32 may correspond to any means of obtaining, receiving, transmitting or providing analog or digital signals or information, such as any port, contact, pin, register, input port, output port, conductor, track, etc., which allows a signal or information to be provided or received. The interface 32 can be wireless or wired and can be configured so as to be able to communicate with other internal or external components, e. g. to transmit or receive signals or information.

In at least some exemplary embodiments the vehicle 40 can correspond, for example, to an agricultural vehicle, a water-borne vehicle, an aircraft, a railway vehicle, a road vehicle, a car, a bus, a motorcycle, an all-terrain vehicle, a motor vehicle or a heavy goods vehicle. The apparatus 30 can be, for example, a control device or a part of a control device of the vehicle 40.

Further details and aspects are mentioned in conjunction with the exemplary embodiments described above. The exemplary embodiment shown in FIG. 3 can have one o more optional additional features corresponding to one or more aspects mentioned in connection with the proposed design or with one or more exemplary embodiments described above (e.g. FIGS. 1-2).

Further exemplary embodiments are computer programs for carrying out any of the methods described herein, when the computer program is executed on a computer, a processor or a programmable hardware component. Depending on the specific implementation requirements, exemplary embodiments can be implemented either in hardware or in software. The implementation can be carried out by using a digital storage medium, such as a floppy disk, a DVD, a Blu-Ray disc, a CD, a ROM, a PROM, an EPROM, an EEPROM or Flash memory, a hard disk or other magnetic or optical storage on which electronically readable control signals are stored, which can interact or interact with a programmable hardware component in such a way that the respective method is carried out.

A programmable hardware component can be formed by a processor, a computer processor (CPU =Central Processing Unit), a graphics processing unit (GPU =Graphics Processing Unit), a computer, a computer system, an application-specific integrated circuit (ASIC), an integrated circuit (IC), a single-chip system (SOC=System-on-Chip), a programmable logic element or a field-programmable gate array (FPGA) with a microprocessor.

The digital storage medium can therefore be machine-or computer-readable. Some exemplary embodiments thus comprise a data £ carrier, which has electronically readable control signals that are capable of interacting with a programmable computer system or programmable hardware component in such a way that one of the methods described herein is carried out. One exemplary embodiment therefore is a data carrier (or a digital storage medium or a computer-readable medium), on which the program is recorded for carrying out one of the methods described herein.

In general, exemplary embodiments can be implemented as software, firmware, computer programs or a computer program product with a program code or as data, wherein the program code is, or the data are, effective in terms of carrying out one of the methods if the program is running on a processor or programmable hardware component. The program code or the data can also be stored, for example, on a machine-readable medium or data carrier. The program code or the data can exist in the form of source code, machine code or byte code, among other things, as well as other intermediate code.

The examples described above only represent an illustration of the principles of the present invention. It is implicit that modifications and variations of the arrangements and details described herein will be apparent to other persons skilled in the art. It is therefore intended that the invention be limited only by the scope of protection of the following patent claims and not by the specific details, which have been presented herein on the basis of the description and explanation of the exemplary embodiments.

### LIST OF REFERENCE SIGNS

30 Apparatus
32 Interface
34 Data processing circuit
40 Vehicle
100 Method for checking a piece of software for controlling a vehicle function
110 Transmitting a control signal to a control unit
120 Receiving a status signal from a control device
130 Checking the piece of software based on the status signal
200 Method for checking a piece of software for controlling a vehicle function
210 Receiving a control signal from a communication device
220 Triggering a movement of the user terminal based on the control signal

1.-10. (canceled)

11. A method for checking a piece of software for controlling a vehicle function of a vehicle, wherein the software allows access to the vehicle, comprising:
transmitting, to a control unit, a control signal indicative of a movement of a user terminal on a trajectory along the vehicle;
receiving a status signal indicative of a vehicle status; and
checking the software based on the status signal.

12. The method as claimed in claim 11, wherein:
the status signal further comprises information indicative of a position of the user terminal; and
checking the software further comprises checking the software based on the position of the user terminal.

13. The method as claimed in claim 12, further comprising:
receiving, from the control unit, a position signal indicative of the position of the user terminal.

14. The method as claimed in claim 12, further comprising:
transmitting, to the control unit, a shielding signal indicating a shielding to be caused between the user terminal and the vehicle.

15. The method as claimed in claim 11, further comprising:
transmitting, to the control unit, a shielding signal indicating a shielding to be caused between the user terminal and the vehicle.

16. An apparatus for checking a piece of software for controlling a vehicle function, comprising:
a data processing circuit configured to carry out the method as claimed in claim 11; and
an interface for communication with the control unit.

17. A vehicle having the apparatus as claimed in claim 16.

18. A non-transitory storage medium having a computer program for carrying out the method as claimed in claim 11, when the computer program is executed on a computer, a processor or a programmable hardware component.

19. The method as claimed in claim 11, wherein the control unit is a control unit of a robot.

20. The method as claimed in claim 11, wherein the user terminal is configured as a digital key.

21. A method for checking a piece of software for controlling a vehicle function, wherein the software allows access to the vehicle, comprising:
receiving, from a communication device, a control signal indicative of a requested movement of the user terminal on a trajectory along the vehicle; and
triggering a movement of a user terminal based on the control signal.

22. The method as claimed in claim 21, further comprising:
receiving, from the communication device, an orientation signal indicative of an orientation of the user terminal; and
triggering a change in the orientation of the user terminal based at least on the orientation signal.

23. The method as claimed in claim 22, further comprising:
determining a position of a marker of the vehicle;
determining a position of the user terminal relative to the vehicle based on the determined position of the marker; and
transmitting, to the communication device, a position signal indicative of the position of the user terminal.

24. The method as claimed in claim 21, further comprising:
determining a position of a marker of the vehicle;
determining a position of the user terminal relative to the vehicle based on the determined position of the marker; and
transmitting, to the communication device, a position signal indicative of the position of the user terminal.

25. A non-transitory storage medium having a computer program for carrying out the method as claimed in claim 21, when the computer program is executed on a computer, a processor or a programmable hardware component.

26. The method as claimed in claim 21, wherein the user terminal is configured as a digital key.

27. An apparatus for checking a piece of software for controlling a vehicle function, comprising:
a data processing circuit configured to carry out the method as claimed in claim 21.
an interface for communication with the communication device.

28. A vehicle having the apparatus as claimed in claim 27.
